(19) United States
(12) Patent Application Publication
(10) Pub. No.: US 2003/0221599 A1
(43) Pub. Date: Dec. 4, 2003

(54) "Low ground disturbance liquid manure applicator"

(76) Inventors: Danny Kinsella, Alix (CA); Greg Hodges, Innisfail (CA)

Correspondence Address: Sean W. Goodwin, Goodwin Berlin McKay, The Burns Building, Suite 360, 237-8th Avenue S.E., Calgary, AB, T2G 5C3, CA

(21) Appl. No.: 10/157,833

(22) Filed: May 31, 2002

(51) Int. Cl. A01C 23/00

(52) U.S. Cl. 111/121

(57) ABSTRACT

A liquid manure applicator comprises a frame having support wheels mounted to a carriage movable relative to the frame and one or more transversely extending shafts of tines positioned rearward of the support wheels. Rearward of the tines are distributed one or more sprays. The frame is mounted to the vehicle through vertically reciprocating parallelogram linkage which permits the frame to move vertically while maintaining the orientation of the frame and the ground. The supporting wheels are pivoted so as to passively steer as the frame is moved laterally. The elevation of the tine assemblies and sprays relative to the ground is adjusted through manipulation of the height of the supporting wheels. A minimal number of large bore clog resistant sprays is used, supplied from a distributor.

### FIELD OF THE INVENTION

This invention relates to apparatus for spreading a slurry of liquid manure, and more particularly, to apparatus projecting from the rear of a manure tanker vehicle and for low odor application of the manure into shallow cavities formed in ground by aeration tines.

### BACKGROUND OF THE INVENTION

Liquid manure is used as a fertilizer and its application on ground aids significantly in disposal problems and manure management generally. Manure may be collected by the individual farmer or be available from other centralized waste treatment facilities. Disposal of the manure, however valuable as fertilizer, is subject to some challenges. Solids content in liquid manure is not usually very finely graded and can have a less than uniform consistency. Such a liquid can have an unpredictable ability to flow through process piping and is associated with the release of odor.

Conventionally, liquid manure is provided or formed into a slurry which is then pumped into a vehicle mounted-tank. The vehicle drives about an application site and the manure is distributed to the ground in one of a variety of techniques. Today there is an objective to maximize incorporation of the manure's nutrients into the ground while minimizing ground disturbance and minimizing release of odors. Some techniques spread the manure on the surface using a fan nozzle, similar to a construction site water truck, which has the advantage of simplicity in that it is usually tank mounted and does not require the additional hardware of a trailer. An example of one such approach is disclosed in U.S. Pat. No. 4,014,271 to Rohlf et al.. However, as a result of the rather crude spray application from a large fan discharge, spaced high above the ground, there is typically a significant odor release associated with such a technique. As a result, other techniques have been developed which apply the manure into a cavity formed in the ground. In U.S. Pat. No. 5,357,883 to Depault, a trailer fitted with plow teeth are used to disturb the ground immediately ahead of nozzles distributing a manure slurry. The plow teeth are spring mounted and are intended to be self depth-regulating as a function of ground compaction, often resulting in deeper tillage. The plow approach is less favorable due to ground erosion aspects.

To minimize ground erosion by avoiding tilling, there have been some aerating technologies applied. For instance, as disclosed in U.S. Pat. No. 4,840,232 to Mayer, Aerway (of the Holland Group of Companies, Woodstock, Ontario, Canada) has a towed unit hitched to a vehicle having a plurality of aerating tines which engage and dig into the ground under the weight of the towed equipment. It is suggested that additional weight can be added to the frame of the trailer as needed. Aerways' aerating apparatus has been adapted for manure spreading (Model SSD) through the addition of a plurality of liquid nozzles (about one nozzle per tine distributed across the width of the apparatus). Disadvantages, such as odors associated with distribution through a few number of sprays is reduced through substitution with many nozzles spaced close to the ground. Due to the number of nozzles, many small hoses are used (up to about 24 nozzles and hoses for a 30 foot width) and the chance of plugging is increased. As a result, Aerway also provides a rotating nozzle distributor to pulse slurry into each hose, and further, a chopper is optionally employed to further reduce plugging when used with heavier slurries and fibrous materials. The Aerway apparatus is towed behind a vehicle and uses trailing wheels for mobility and as means for adjusting the height of the tines. The wheels trail the tines and manure nozzles and are caused to roll through the freshly deposited manure and therefore tracking of manure is possible which is a disadvantage as the apparatus leaves the fields for transport on public roads.

Aerway and others use trailer towed apparatus which are a challenge to maneuver when the vehicle is backing up, the result being lost time, and occasional jackknifing of the trailer. Backing up is inevitable when maneuvering to refill a tank from a fixed source.

Alternately, some known apparatus transfer liquid manure directly to the apparatus during application, using a long hose extending from a pump situated at the lagoon. As the rate of supply of manure to the apparatus is controlled solely by the pump at the lagoon, there is little control by the operator over application rates, particularly when the apparatus must be slowed for operations such as turning corners, contributing to over-application.

Clearly there is a need for apparatus that is capable of spreading liquid manure without the need for deep tillage thereby reducing erosion. Further, the apparatus should avoid excessive odor by applying the manure at the soil rather than broadcast spraying and should not track large amounts of manure onto public roadways during transport from field to field. The apparatus should be easily handled, which includes the ability to track the towing vehicle when backed up, particularly for repeated filling from a source of liquid manure and further, includes the ability to control the rate of application throughout the operation. All of these should be accomplished with a minimum of plugging as a result of manure solids.

### SUMMARY OF THE INVENTION

The invention provides an improved apparatus for applying liquid manure to ground. In its preferred form, the apparatus utilizes tines which are set for minimal ground disturbance and large bore fan sprays, closely spaced from the ground, for spreading liquid manure from a lagoon or the like without further processing and with reduced plugging. Due to the arrangement for mounting the apparatus to the tow vehicle and the positioning of the wheels, the apparatus is particularly convenient to the operator during both maneuvering and operation and is acceptable for re-entry to public service roads. The apparatus comprises a frame having support wheels and one or more transversely extending shafts of tine assemblies trailing the wheels. Further rearward or trailing the tine assemblies are distributed one or more fan sprays. The axes of the tine assemblies and the sprays are arranged so that their elevations are known and are typically and substantially the same. The frame is mounted to the vehicle through a vertically reciprocating parallelogram linkage which permits the frame to move vertically while maintaining the orientation of the frame with the ground. Use of a parallelogram linkage to a trailer frame which is rigid side-to-side is normally associated with handling difficulties in turning the vehicle. Thus, the wheels supporting the trailer are passively steerable so as to follow the frame automatically upon any lateral impetus such as that imposed when the rear of the vehicle swings laterally upon turning. Maintaining the orientation is useful so that the elevation of the tines and sprays remains constant and close to the ground. Elevation of the tines, and sprays, relative to the ground is adjusted through manipulation of the height of the supporting wheels.

Preferably, there are a minimal number of large bore sprays, one located at the middle of each section of the transverse member, each having a distribution width of roughly the same width as the section and the tine assemblies. The sprays are located close to the ground to reduce carriage of the manure and associated odors, by the wind.

A slurry pump situated on the towing vehicle permits direct feeding of the manure, previously loaded onto the vehicle's tank at the lagoon, to the apparatus for distribution without plugging. Further, the addition of controls for the pump within the towing vehicle permit the operator to control the rate of distribution throughout the operation.

### BRIEF DESCRIPTION OF THE DRAWINGS

FIGS. 1a and 1b are schematic plan views of the apparatus connected to a towing vehicle and illustrating a traveling position in FIG. 1a and an operating tine-engaging position in FIG. 1b;

FIG. 2 is a partial cross-sectional view with shafts and tines removed for clarity of viewing the parallelogram linkage, frame and wheel pivot;

FIGS. 3a-3c are schematic plan views of the apparatus connected to a towing vehicle having the wings folded and manure distribution components removed for clarity. FIG. 3a illustrates the frame being towed straight forwards or rearwards; FIG. 3b illustrates the frame being manipulated as the front of the vehicle is turned left forwards or backed up right rearwards; FIG. 3c illustrates the frame being manipulated as the front of the vehicle is turned right forwards or backed up left rearwards;

FIG. 4 is a top view of a portion of the frame and support wheels the shafts shown with most tines removed for simple illustration of the frame;

FIGS. 5a and 5b are end views of two portions of the rear of a practical implementation of the apparatus. FIG. 5a is an end view of the main frame and FIG. 5b is a left side wing in the lowered position, shown in exploded view from the frame of FIG. 5a;

FIG. 6 is an end view of the apparatus of FIGS. 5a, 5b with both left and right wings in the folded positions and the frame lifted from the wheels for traveling;

FIG. 7 is a top view of the frame of FIGS. 5a and 5b, the shafts shown with most tines removed for simple illustration of the frame;

FIG. 8a is a cross-sectional view through a typical shaft fitted with tine assemblies, one tine assembly being illustrated in an exploded view;

FIG. 8b is a cross-sectional view through the shaft of FIG. 8a, illustrating the arrangement of four equispaced tine assemblies prior to securing the annular flanges to sandwich the tines; and

FIGS. 9a and 9b are side and front cross-sectional views of a fan spray.

### DETAILED DESCRIPTION OF THE PREFERRED EMBODIMENT

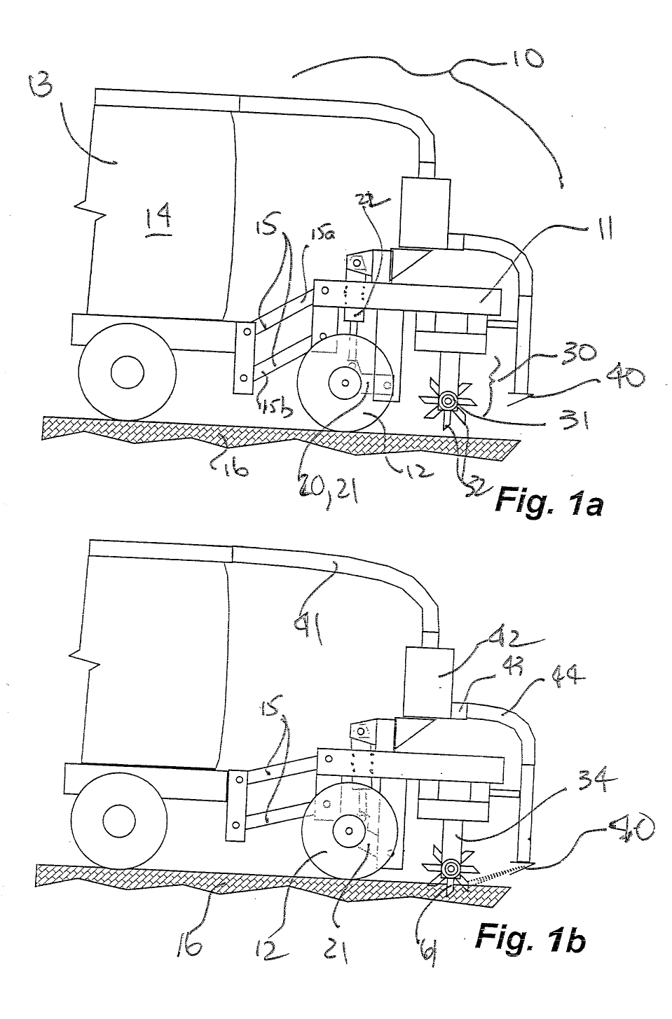

With reference to FIGS. 1a and 1b, the apparatus or applicator 10 comprises a frame having support wheels 12 mounted at the front of the applicator 10. The applicator 10 is mounted at the rear of a vehicle 13 such as tanker truck 13 which carries a tank 14 of liquid manure. The frame 11 of the applicator 10 is adapted to mount to the vehicle 13 through a vertically reciprocating parallelogram linkage 15 which permits the frame to move vertically while maintaining the orientation of the frame 11 and the ground 16. The linkage 15 comprises two upper bars 15a and two lower bars 15b, each having parallel pivoting axes.

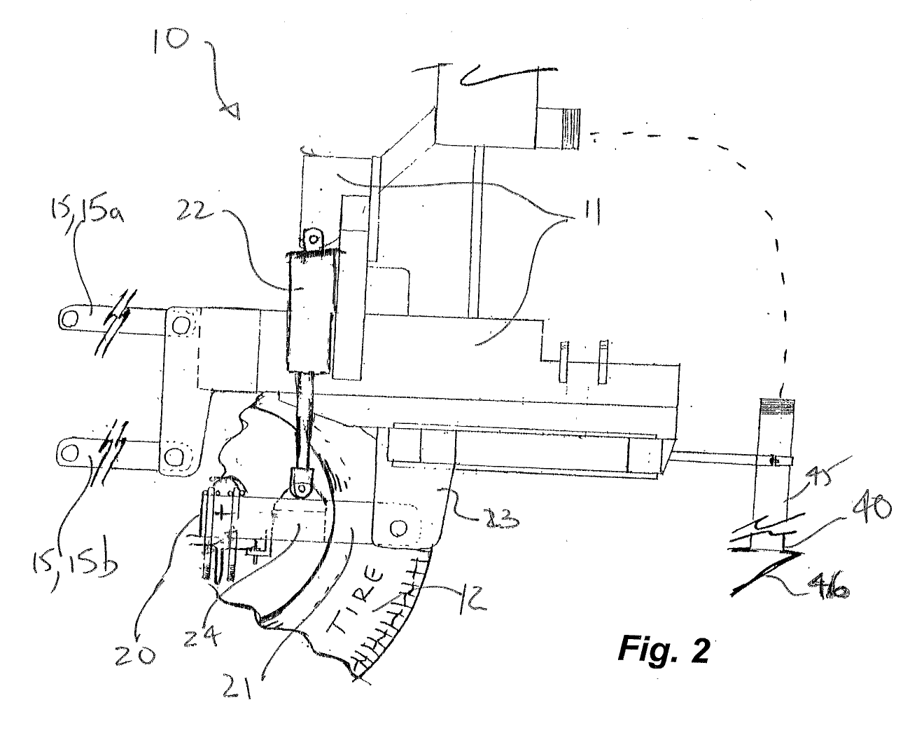

The support wheels 12 are mounted to a carriage 20 which is supported transversely on a pair of arms 21. The arms 21 are pivotally mounted under the frame 11 for enabling adjustment of the relative spacing between the frame 11 and the wheel 12. An actuator such as a hydraulic cylinder or ram 22 extends between the carriage 20 and the frame 11. As shown in FIG. 1a, as the ram 22 is extended, the frame 11 is raised relative to the wheels 12 and the ground 16. With reference to FIG. 2, the arms 21 are pivoted from a support 23 and the hydraulic ram 22 is connected between the frame 11 and a mount 24 on the carriage 20. The hydraulic ram 22 is powered using a hydraulic power supply provided by the vehicle.

Ground penetrating assemblies 30 are provided for penetrating and enhancing the ground 16 for accepting the liquid manure. One form of ground penetrating assembly 30 is one or more transversely extending shafts 31 which rotatably supported from the frame 11. The shafts 31 are fitted with a plurality of tine assemblies 32. Further one or more large bore fan sprays 40 are supported from the frame 11 and are distributed transversely across the applicator rearward of the tine assemblies 32.

The shafts 31 and the sprays 40 are arranged so that their elevations from the ground 16 are known and are typically and substantially the same. Maintaining the relative orientation (though the parallelogram linkage 15) is useful so that the elevation of the tine assemblies 32 and sprays 40 remains a constant. Elevation of the tine assemblies, and sprays, relative to the ground 16 is adjusted through manipulation of the height of the frame 11 from the supporting wheels 12.

In the particular case shown in FIG. 1a, by extending the ram 22 and raising the frame 11, the shafts 31 and tine assemblies 32 are also raised. With sufficient actuation of the ram 22, the tine assemblies 32 can be raised clear of the ground 16 such as is the case for transporting the applicator 10 on public highways or roads (traveling).

With reference to FIG. 1b, by incrementally adjusting the retraction of the ram 22 and thereby lowering the frame 11, the shafts 31 and tine assemblies 32 lower to the ground 16 for forming shallow small triangular cavities or pockets in the ground 16. The weight of the applicator 10 causes tine assemblies 32 to penetrate into the ground, the positioning of the ram 22 controlling the depth of penetration. The forward action of the applicator causes the shaft 31 and tine assemblies 32 to rotate. When the tine assemblies 32 are engaged with the ground 16, the sprays 40 are positioned at an elevation optimal for spray distribution of the liquid manure into the pockets formed in the ground.

Liquid manure, loaded into the tank 14 at a lagoon (not shown) is delivered from the tank 14, through a feed hose 41 and to a header or distributor 42. Particularly, the liquid manure is gravity fed from the tank 14 to a slurry pump (not shown) attached at the bottom of tank 14 and then is pumped to the feed hose 41.

The distributor 42 has one or more outlets 43 and distribution hoses 44 for directing liquid manure to one or more sprays 40. The number of sprays 40 is minimized, and their bore maximized, so as to maximize the volumetric throughput. Large diameter hose 44 and large bore sprays 40 are less likely to clog and thereby obviates the need for an expensive chopper as is typically applied in the prior art.

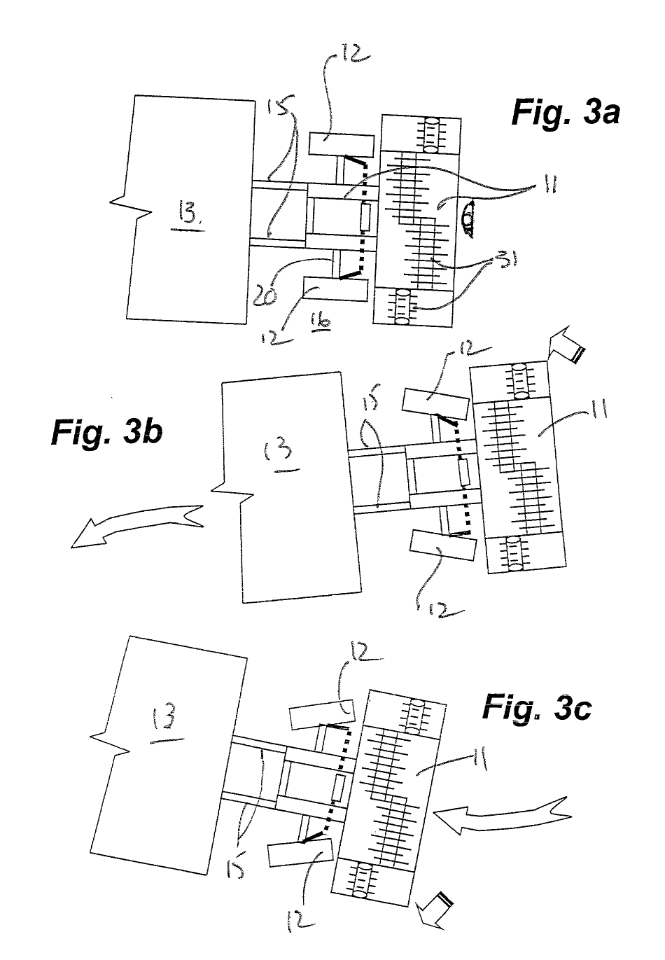

Turning to FIGS. 3a-3c, while beneficially enabling parallel orientation of the frame 11 and the ground 16 during frame movement, the parallelogram linkage 15 can introduce handling difficulties while turning the vehicle 13. The nature of a conventional parallelogram linkage 15 is that it is typically rigid laterally. As shown in FIG. 3a, while the vehicle 13 is operated straight ahead or in reverse, the frame 11 and wheels 12 follow without difficulty. However, as shown in FIGS. 3b and 3c, when the vehicle 13 is turned, the frame 11 slews to the side and, without some compensation means, the support wheels 12 would scrub or drag laterally.

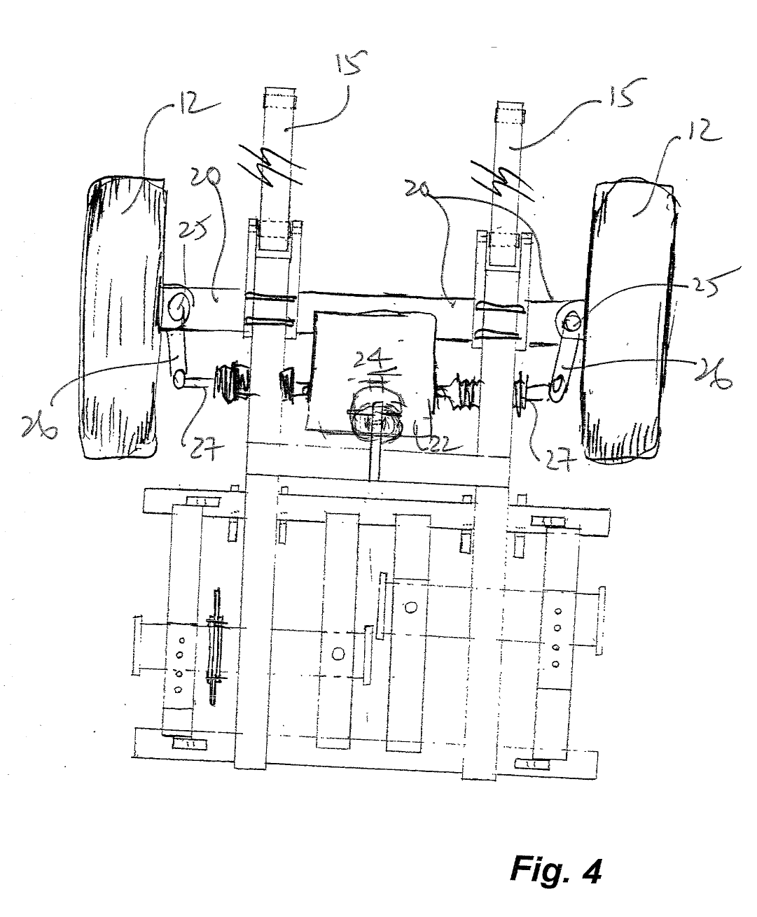

Accordingly, as shown in FIG. 3b (advance while turning left), and FIG. 3c (advance while turning right) the supporting wheels 12 are passively steerable, like casters, so as automatically follow the direction of movement upon any lateral impetus such as that imposed when the rear of the vehicle swings upon turning. Referring also to FIG. 4, the wheels 12 are rotatably mounted on the ends of the transversely extending carriage 20. The carriage 20 can be an axle such as that found on the front suspension of trucks. The carriage is fitted with conventional hubs (not detailed) which rotate about a vertical pivots 25 to permit the orientation of the wheels 12 to change. The hubs have steering arms 26 which are each connected using resistive members 27 extending to the frame 11. The resistive members 27, such as shocks, dampen the pivoting steering of the wheels 12.

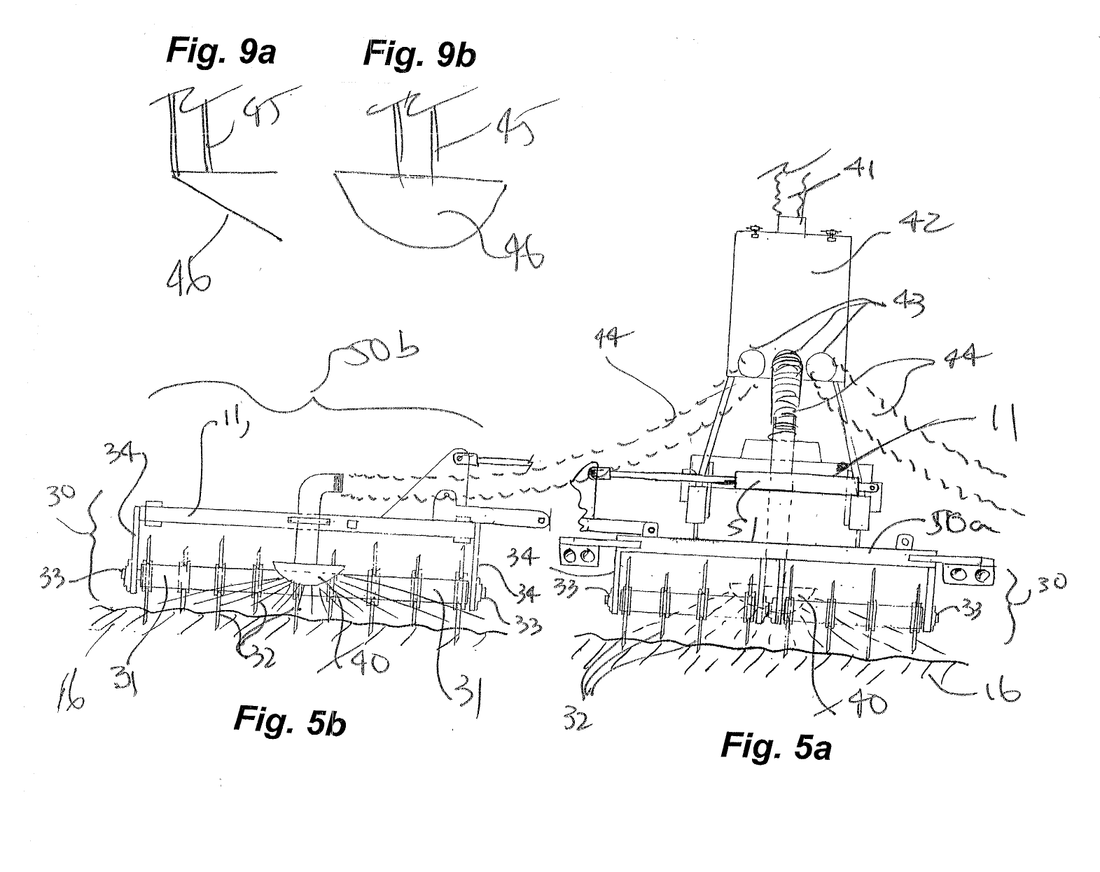

With reference to FIGS. 5a and 5b, a transverse member 50 portion of the frame 11 and behind the wheels for supporting one or more rotating shafts 31. Each shaft 31 has a plurality of radially extending tine assemblies 32 for penetrating the ground 16.

As shown, the member 50 is formed in three separate sub-frames or sections; a central section 50a and two laterally extending wing sections 50b,50c. Shafts 31 are supported on brackets 34 extending downwardly from each section 50a,50b,50c. The wing sections 50b,50c are pivotally connected to left and right sides of the central section 50a and are upwardly foldable through hydraulic rams 51 when not in use so as to narrow their profile for traveling.

Only the center section 50a and left wing section 50b are shown in FIGS. 5a,5b. A right wing section 50c is not shown and the left wing section 50b of FIG. 5a is shown separated from the central section 50a at its pivot and connection to its folding hydraulic ram 51. Only one hydraulic ram 51 is actually illustrated as the opposing and mirrored hydraulic ram for the right wing section would obscure the hydraulic ram 51 for the left wing section 50b.

In FIG. 5a, one large bore spray 40 (in dotted lines) is illustrated feeding liquid manure from the distributor 42 and distributing it as a substantially uniform spray across the width of the central section 50a. In FIG. 5b, one spray 40 is illustrated which has an aspect capable of distributing liquid manure across the width of the left wing section 50b. Turning also to FIGS. 9a and 9b, the sprays are typically large bore pipes 45 which discharge a liquid manure stream to impact a fan plate 46.

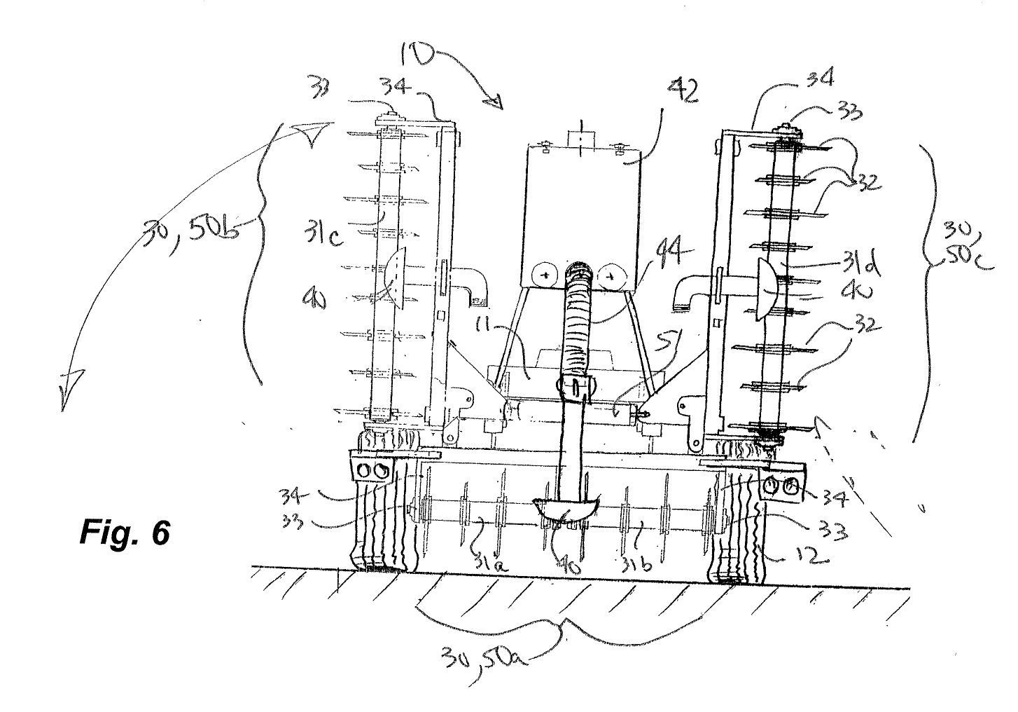

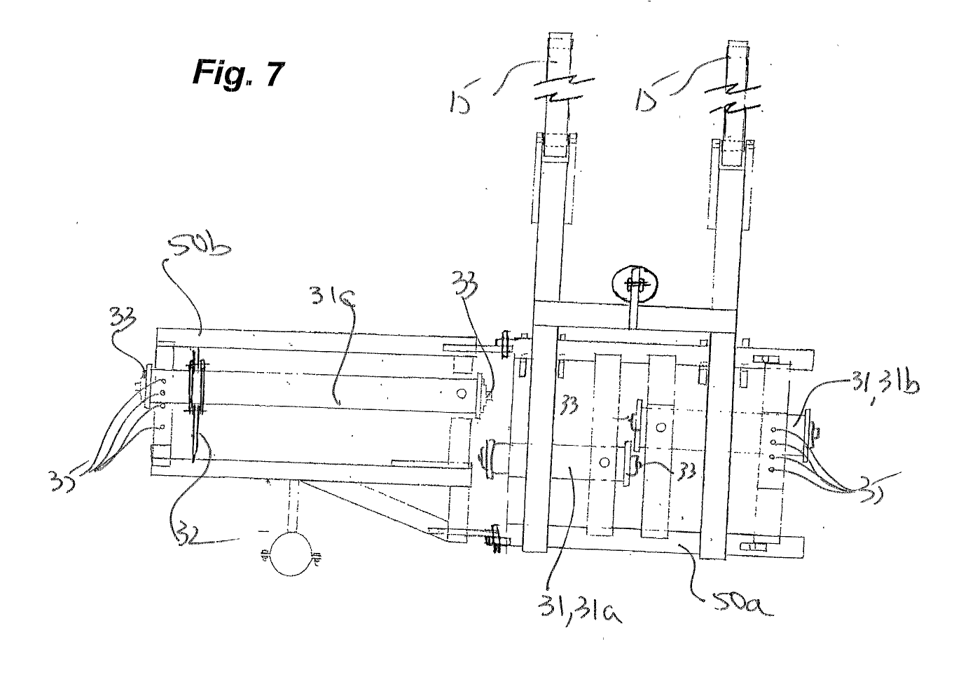

With reference to FIG. 6, for traveling, the left and right wing sections 50b,50c fold upwardly for narrowing the transport width of the applicator 1 0.

Turning to the arrangement of the shafts 31 and tine assemblies 32 in FIGS. 6,7, the central section 50a can support two shafts 31a,31b, shown only with one tine assembly 32 so as to emphasize the shaft arrangement. The shafts 31a,31b are rotatably supported with bearings 33 at each end mounted to the downwardly extending brackets 34. To maximize transverse coverage and avoid forming oversized gaps in the distribution of tine assemblies 32, the two shafts 31a,32b are staggered fore and aft to avoid interference between the bearings 33. The bracket 34 at one end of each shaft 31 can be repositioned further forwards or rearwards of the other bracket and secured at one of multiple pin points 35,35. . . So that the shafts 31a,31b can be angled off of a perpendicular to the movement of the applicator.

Similarly, the wing sections 50b,50c can be fitted with shafts 31c,31d which also can be similarly angled by incrementally pinning the shaft support bracket at one of multiple pin points 35.

In FIGS. 5a,5b, a minimum number of sprays 40 are positioned behind the tine assemblies 32 for applying liquid manure onto the penetrated ground 16, each spray 40 being connected by a large hose 44 to the distributor 42. Preferably, there are three sprays 40, one located at the middle of each section 50a,50b,50c, each having a wide spray discharge being roughly the same width as the respective section. The sprays 40 are located close to the ground 16 to minimize picking up liquid manure and associated odors, by the wind. Through a reduction in the numbers of sprays 40, the flow to each spray is greater and the opportunity for blockage or clogging is reduced. For instance, the sprays can be formed of 4” schedule pipe 45 which discharges onto a 45 degree inclined deflection fan plate 46.

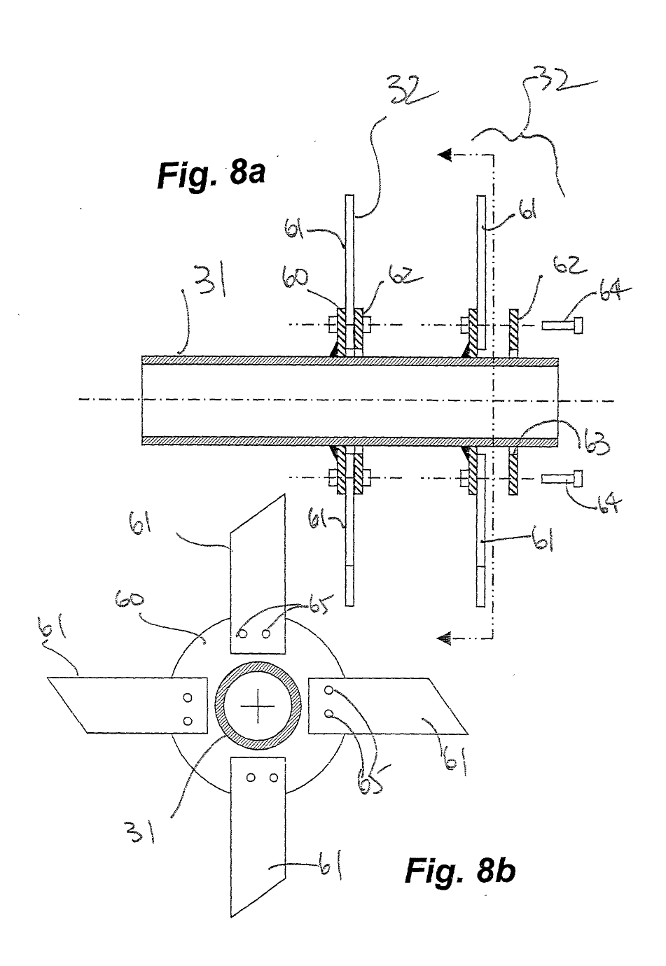

With reference to FIGS. 8a and 8b, each tine assembly 30 comprises a first annular flange 60 mounted or secured to the shaft 31, such as by welding. Individual radially extending tines 61 are secured by sandwiching them between the first 60 flange and a second annular flange 62. The second flange 62 has a bore 63 which is sized so as to be axially slidable over the shaft 31. Each second flange 62 is installed to the shaft 31 prior to securing the first flanges 60. Fasteners 64 secure tines 61 between the flanges 60,62. The fasteners 64 flanges can extend through holes 65 in the flanges and the tines securing the tine assembly 32 together. Other arrangements of fasteners 65 also include the use of bolts extending through holes in the second flange and tines to a threaded portion of the first flange or studs extending from the first flange. Should a damaged tine 61 need to be replaced, or if a different configuration of tine is desired, then they are easily replaced by loosening the second flange 62 and removing the fasteners 65 for the specific tine.

Best seen in FIGS. 1a, 1b, 3a-3c, in operation, the frame's parallelogram linkage 15 is connected to the vehicle 13 for towing. The hydraulic ram 22 is actuated to raise the frame 11 over the support wheels 12. If the applicator 10 has wing sections 50b,50c, then they are folded upwardly to reduce the applicator's width and the vehicle transports the applicator 10 to a field targeted for application. The wing sections 50b,50c are then lowered using the hydraulic rams 51 and, to commence liquid manure distribution, the frame 11 is lowered on the support wheels 12 so as to engage the tine assemblies 32 with the ground 16. The desired depth of penetration of the tines 61 into the ground is determined by the relative spacing between the frame 11 and wheels 12 and the weight of the applicator 10. The spacing of the sprays 40 to the ground 16 is governed by the penetration depth of the tines 61. The vehicle 13 is advanced with the applicator 10 trailing behind. The tines assemblies 32 engage the ground 16, rotating the shafts 31 and bringing a successive tine 61 into contact with the ground as a preceding tine 61 disengages the ground, leaving behind a liquid manure accepting pocket. The sprays 40 dispense liquid manure for distribution substantially across the entire width of the applicator 10. The sprays 40 deposit the liquid manure behind the rest of the applicator 10 and therefore is not further disturbed or tracked onto public roadways. The angle of the shafts 31 and their tine assemblies 32 can be skewed to increase the amount of disturbance introduced into the ground 16.

The embodiment shown has wing sections 50b,50c for widening the track of the applicator 10. The wing sections are optional and useful for facilitating road travel, however the frame 11 could be continuous across its full width without implementing a folding capability. Further, the frame 11 may simply be made narrower comprising merely the central section alone. The number of tine assemblies 32 can be varied. A suitable density of tine assemblies 32 is typically spacing of about 7 inches apart and tines having 4 inch wide blades having a 45 degrees bevel at their ground engaging end. Other densities and tine configuration are equally suitable.

Some advantages of the applicator include:

the vehicle and tanker are easily backed up for maneuvering as the laterally rigid hitch prevents the implement from jackknifing, particularly for repeated refilling of the tank at the lagoon;

the large flow lines avoid plugging, obviating the need for a chopper, and permitting and on-board pump for elimination of maintaining na umbilical to a remote lagoon;

the supporting wheels are forward of the tines and sprays so as to minimize tracking of liquid manure onto public roads and highways;

periodic and spaced sprays implement large diameter supply hoses which are less likely to clog which aids in minimizing or eliminating the need for a slurry chopper;

the parallelogram linkage and hydraulics permit convenient raising of the frame for traveling and yet, in use, the ground engagement of the tines and the depth of piercing of the ground can be controlled for low tillage; and

the spray is controlled and maintained close to and in known relation to the ground regardless of the applicator height and tine penetration.

Other embodiments of the invention will also be readily apparent to a person skilled in the art, the scope of the invention being defined in the appended claims.

The embodiments of the invention in which an exclusive property or privilege is claimed are defined as follows:

1. Apparatus for the application of liquid manure onto ground comprising:
a frame;
a parallelogram linkage adapted for connecting the frame to a tow vehicle for enabling vertical movement of the frame relative to the vehicle and the ground;
support wheels for engaging the ground and rotatably mounted to a carriage movable relative to the frame;
one or more ground penetrating assemblies supported from and extending transversely across the frame rearward of the support wheels;
actuating means between the carriage and the frame for raising and lowering the frame relative to the ground between a traveling position, having the ground penetrating assembly above the ground, and a ground penetrating position, having the ground penetrating assembly engaging the ground; and
sprays positioned rearward of the ground penetrating assembly for distributing liquid manure on the ground behind and substantially across the width of the ground penetrating assemblies when positioned in the ground penetrating position.

2. The apparatus of claim 1 wherein the support wheels are passively steerable for permitting lateral motion of the frame.

3. The apparatus of claim 2 wherein the ground penetrating assemblies comprise:
one or more shafts rotatably supported and extending transversely across the frame; and
a plurality of tine assemblies spaced along the one or more shafts, each tine assembly having two or more radially extending tines.

4. The apparatus of claim 3 wherein the sprays comprise:
one or more sprays at a predetermined elevation relative to the frame, each spray having a wide lateral aspect for the distribution of liquid manure transversely across the plurality of tine assemblies.

5. The apparatus of claim 4 wherein each of the one or more shafts further comprises;
a support mount at each end of the shaft, the support mount depending from the frame and having a bearing end for rotatably supporting the shaft; and
means for adjusting one support mount forwards or rearwards so as to skew the shaft and thus skew the tine assemblies as they penetrate the ground.

6. The apparatus of claim 1 wherein the actuating means is a hydraulic ram.

7. The apparatus of claim 3 wherein each tine assembly further comprises:
a first annular flange mounted for rotation with the shaft;
a second annular flange having a bore which is axially slidable over the shaft;
two or more tines which are angularly spaced and sandwiched between the first and second annular flanges; and
fasteners for mounting the second flange to the first flange for securing the two if more tines for rotation with the first flange.

8. The apparatus of claim 7 wherein each tine assembly further comprises:
two or more holes formed in each tine; and
two or more holes formed in the second flange for each tine and wherein the fasteners comprise bolts extending through each of the holes in the tines and the second flange.

9. The apparatus of claim I further comprising left and right wing sections extending laterally from the frame, each wing section further comprising one or more ground penetrating assemblies supported from and extending transversely across the wing section rearward of the frames support wheels, actuating means between the frame and the wing section to enable pivoting of the wing between a folded traveling position and an unfolded ground position, and sprays positioned rearward of the wing section's ground penetrating assembly for distributing liquid manure on the ground behind to and substantially across the width of the ground penetrating assemblies.

10. Apparatus for the application of liquid manure onto ground comprising:
a frame connected to a tow vehicle, the frame being movable vertically relative to the vehicle and the ground;
support wheels for engaging the ground and rotatably mounted to a carriage movable relative to the frame;
ground penetrating assemblies having one or more shafts rotatably supported and extending transversely across the frame, and a plurality of tine assemblies spaced along the one or more shafts, each tine assembly having two or more radially extending tines supported from and extending transversely across the frame rearward of the support wheels;
actuating means between the carriage and the frame for raising and lowering the frame relative to the ground between a traveling position, having the ground penetrating assembly above the ground, and a ground penetrating position, having the ground penetrating assembly engaging the ground; and
sprays positioned rearward of the ground penetrating assembly for distributing liquid manure on the ground behind and substantially across the width of the ground penetrating assemblies when positioned in the ground penetrating position.

11. The apparatus of claim 9 wherein each tine assembly further comprises:
a first annular flange mounted for rotation with the shaft;
a second annular flange having a bore which is axially slidable over the shaft;
two or more tines which are angularly spaced and sandwiched between the first and second annular flanges; and
fasteners for mounting the second flange to the first flange for securing the two if more tines for rotation with the first flange.

12. The apparatus of claim 10 wherein each tine assembly further comprises:
two or more holes formed in each tine; and
two or more holes formed in the second flange for each tine and wherein the fasteners comprise bolts extending through each of the holes in the tines and the second flange.

13. The apparatus of claim 1 wherein the actuating means is a hydraulic ram.

14. Apparatus for the application of liquid manure onto ground comprising:
a frame;
a parallelogram linkage adapted for connecting the frame to a tow vehicle for enabling vertical movement of the frame relative to the vehicle and the ground;
support wheels for engaging the ground and rotatably mounted to a carriage movable relative to the frame;
ground penetrating assemblies having one or more shafts rotatably supported and extending transversely across the frame, and a plurality of tine assemblies spaced along the one or more shafts, each tine assembly having two or more radially extending tines supported from and extending transversely across the frame rearward of the support wheels;
an actuator positioned between the carriage and the frame for raising and lowering the frame relative to the ground between a traveling position, having the ground penetrating assembly above the ground, and a ground penetrating position, having the ground penetrating assembly engaging the ground; and
sprays positioned rearward of the ground penetrating assembly for distributing liquid manure on the ground behind and substantially across the width of the ground penetrating assemblies when positioned in the ground penetrating position.

15. The apparatus of claim 14 wherein the actuating means is a hydraulic ram.
